(19) United States
(12) Patent Application Publication
(10) Pub. No.: US 2004/0046042 A1
(43) Pub. Date: Mar. 11, 2004

(54) Flavor enhancing drinking system

(76) Inventor: Donald T. Judd, Benbrook, TX (US)

Correspondence Address: Michael S. Neustel, Suite No. 4, 2534 South University Drive, Fargo, ND, 58103, US

(21) Appl. No.: 10/241,562

(22) Filed: Sep. 9, 2002

(51) Int. Cl. A61J 15/00; A47G 21/18

(52) U.S. Cl. 239/33

(57) ABSTRACT

A flavor enhancing drinking system for providing an enhanced drinking experience by combining a candy component, straw and container into one sensory-stimulating package. The flavor enhancing drinking system includes a straw semi-embedded into a candy component with the candy component having at least one opening in connection with the straw. The straw may include an aperture at a point below the candy component. The straw provides for drawing fluid through the straw and candy component combination. The straw may also allow for drawing a fluid through the straw at the aperture at some point below the attached candy component. The fluid-holding container is designed in such a manner as to allow a container, with straw and candy component combination inserted, to be stacked into a second fluid-holding container with straw and candy component combination inserted. The fluid-holding container's design prevents damage when stacked. A covering lid completes the system.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to flavored drinking systems and more specifically it relates to a flavor enhancing drinking system for providing an enhanced drinking experience by combining a candy component, straw and container into a sensory-stimulating package.

2. Description of the Related Art

Drinking straws have been in use for years. They are typically elongated and tubular and made from plastic or paper. Current drinking straws come in a variety of lengths and diameters. Some straws are formed into different shapes and may provide an articulated section of the straw for bending. Drinking straws are currently limited in their application to drawing a fluid through the straw.

Examples of patented devices which are related to the present invention include U.S. Pat. No. 3,545,980 to Stanger; U.S. Pat. No. 3,615,595 to Guttag; U.S. Pat. No. 6,056,206 to Whiton; U.S. Pat. No. 2,576,184 to Jousselin; U.S. Pat. No. 6,109,538 to Villani; U.S. Pat. No. 5,094,861 to D'Auguste; U.S. Pat. No. 4,921,713 to Fowler; and U.S. Pat. No. 662,345 to Britton.

While these devices may be suitable for the particular purpose to which they address, they are not as suitable for providing an enhanced drinking experience. All current combination systems are limited to simply a straw and flavor enhancing method. These systems allow limited interaction by the user with the medium. These systems also limit their use to drawing the drinking fluid through the entire length of the straw thereby restricting the interaction between the candy component and the fluid being drawn through the candy component. Additionally, these systems do not provide a container to maximize the utilization of the drinking system and to provide for easy storage.

In these respects, the flavor enhancing drinking system according to the present invention substantially departs from the conventional concepts and designs of the prior art, and in so doing provides an apparatus primarily developed for the purpose of providing an enhanced drinking experience by combining a candy component, straw and container into one sensory-stimulating package.

### BRIEF SUMMARY OF THE INVENTION

In view of the foregoing disadvantages inherent in the known types of flavored drinking and delivery systems now present in the prior art, the present invention provides a new flavor enhancing drinking system construction wherein the same can be utilized for providing an enhanced drinking experience by combining a candy component, straw and container into one sensory-stimulating package.

The general purpose of the present invention, which will be described subsequently in greater detail, is to provide a new flavor enhancing drinking system that has many of the advantages of the flavored drinking and delivery systems mentioned heretofore and many novel features that result in a new flavor enhancing drinking system which is not anticipated, rendered obvious, suggested, or even implied by any of the prior art flavored drinking and delivery systems, either alone or in any combination thereof.

To attain this, the present invention generally comprises a straw semi-embedded into a candy component with the candy component having at least one opening in connection with the straw. With the straw not extending substantially through the candy component the fluid can more readily interact with the candy component. This interaction will become particularly apparent when the candy component is made from an effervescing candy substance, or the candy component is hollow which may permit the use of solid, or semi-solid fluid candy compositions or gelatinous candy materials, or a combination thereof. Additionally, when the straw is semi-embedded into a candy component, a plurality of openings may be present in the candy component which is in connection with the straw, so that the fluid interacts even more substantially with the candy component. The straw may include a single or plurality of apertures at a point below the attached candy component. The straw would then allow for drawing a fluid through the straw at the aperture at some point below the attached candy component. The combination candy component and straw is insertable into a hollow sleeve in a fluid-holding container. The straw may be flared or include a hook or other protuberance at the end inserted into the hollow sleeve to restrict the straws removal from the hollow sleeve. The fluid-holding container is designed in such a manner as to allow a fluid-holding container, with straw and candy component combination inserted, to be stacked into a second fluid-holding container with straw and candy component combination inserted. This pattern is repeatable and the fluid-holding container's design prevents damage to the candy component when the containers are stacked. A covering lid designed to cover the above-described fluid-holding container and to allow for the insertion and utilization of the straw and candy component combination, completes the system.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a flavor enhancing drinking system that will overcome the shortcomings of the prior art devices.

A second object is to provide a flavor enhancing drinking system for providing an enhanced drinking experience by combining a candy component, straw and container into one sensory-stimulating package.

Another object is to provide a flavor enhancing drinking system that includes candy components of various shapes and sizes.

An additional object is to provide a flavor enhancing drinking system that includes candy components of various flavors.

A further object is to provide a flavor enhancing drinking system that increases point of sales for business establishments selling beverages.

Another object is to provide a flavor enhancing drinking system that includes candy components of various consistencies or of more than one consistency in each candy component.

Another object is to provide a flavor enhancing drinking system that provides a variety of different methods to utilize the straw in the system.

An additional object is to provide a flavor enhancing drinking system that provides a unique and functional fluid-holding container component to the system.

Another object is to provide a flavor enhancing drinking system that provides for easy stacking and storage of the system.

Another object is to provide a flavor enhancing drinking system that provides a covering lid component to prevent spillage when using the system.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the straw.

FIG. 2 is a side view of the straw and the candy component combination.

FIG. 3 is a sectional view of the straw and the candy component combination along line 3-3 of FIG. 2.

FIG. 4 is an upper perspective view of the container.

FIG. 5 is an upper perspective view of the container, a second embodiment of the straw and the candy component.

FIG. 6 is a top view of the container.

FIG. 7 is a top view of the covering lid.

FIG. 8 is an upper perspective view of a stacked container, a second embodiment of the straw and the candy component.

### DETAILED DESCRIPTION OF THE INVENTION

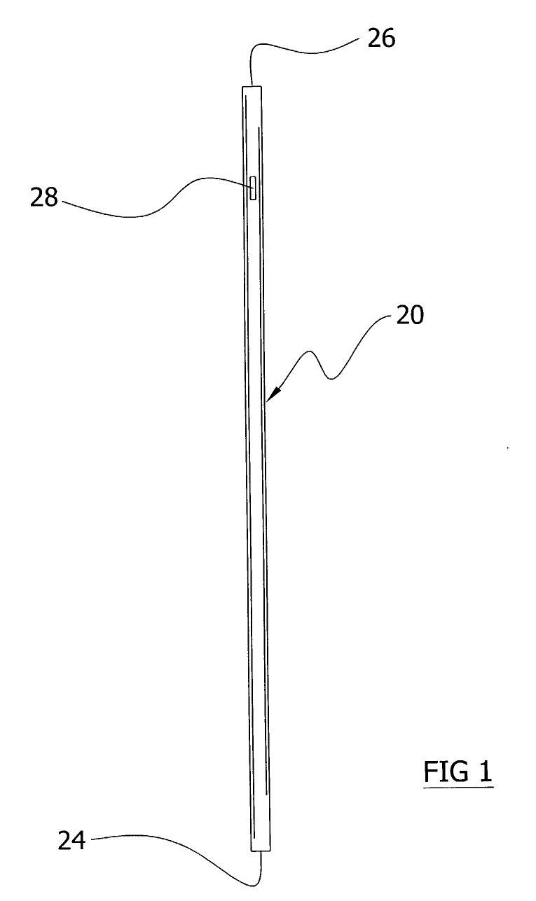

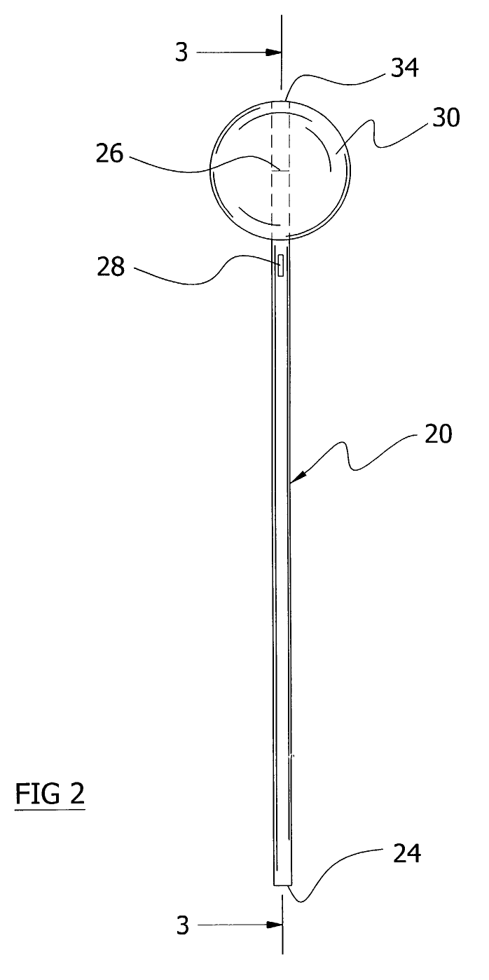

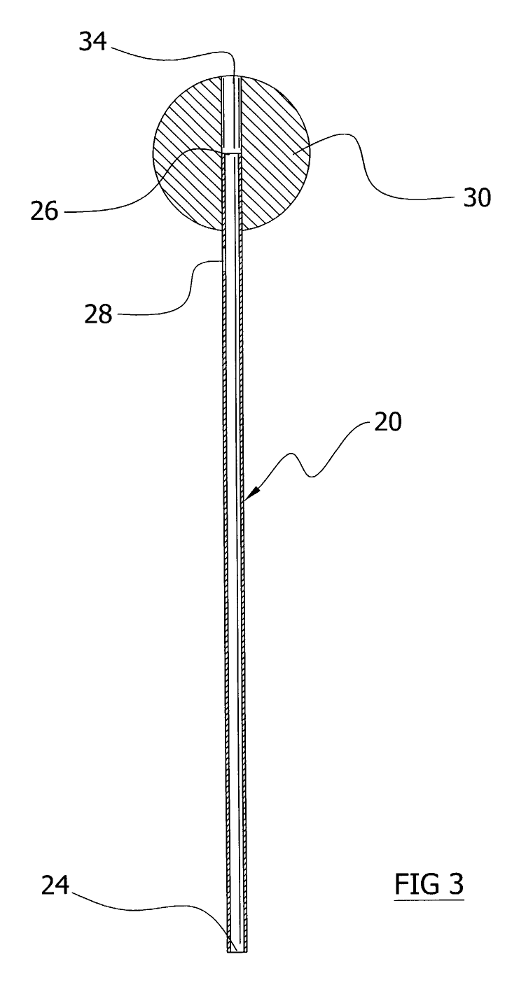

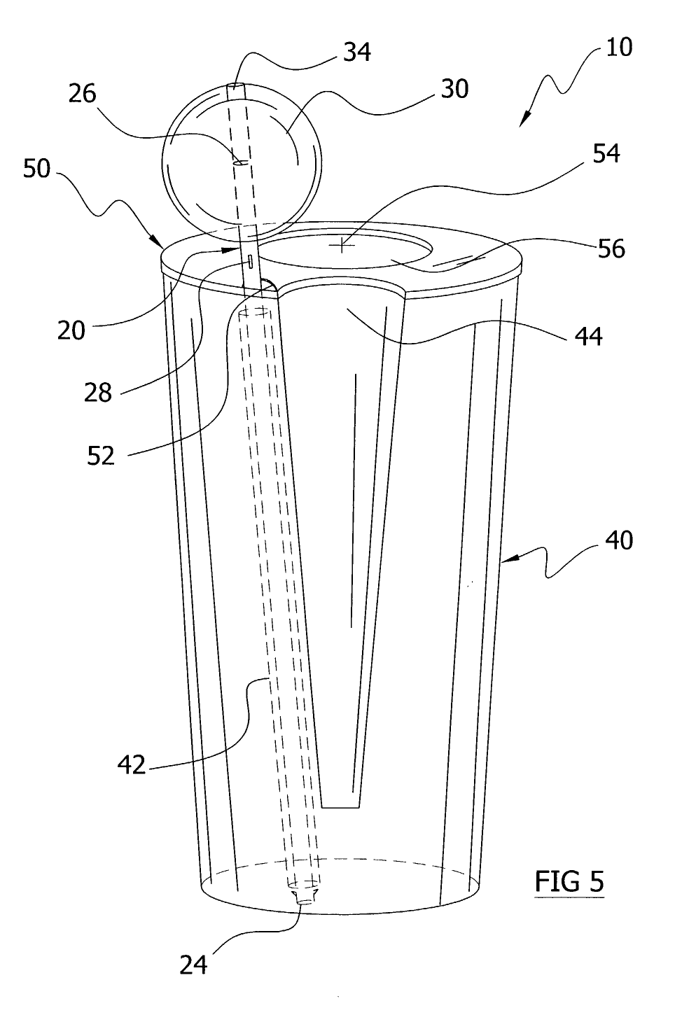

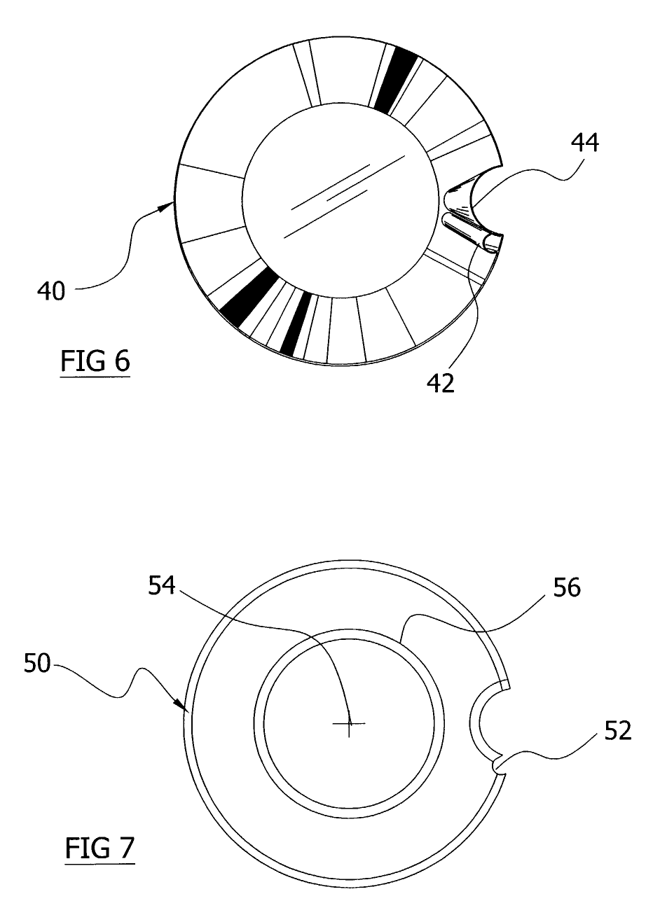

Turning now descriptively to the drawings, in which similar reference characters denote similar elements throughout the several views, FIGS. 1 through 8 illustrate a flavor enhancing drinking system 10, which comprises a straw 20 semi-embedded into a candy component 30. A fluid-holding container 40 has a hollow sleeve 42 attached to the inside of the fluid-holding container 40. A covering lid 50 is attachable to the top of the fluid-holding container 40. The straw 20 with candy component 30 attached is insertable though a cutout 52 in the covering lid 50 and into the hollow sleeve 42 attached to the inner surface of the fluid-holding container 40.

As best seen in FIG. 1, the straw 20 is a hollow cylindrical tube comprising a first end 26 and a second end 24. The straw 20 may have a single aperture 28 or a plurality of apertures 28 on the sides of the hollow cylindrical tube. This aperture 28 is located at a height to be insertable into the mouth of the user and not be covered by the candy component 30. The straw 20 is preferably made of sufficient strength and rigidity to support the candy component's 30 weight. The straw 20 may be flared at the first end 26 to facilitate a secure connection with the candy component 30. The straw 20 may be flared, include a hook or some similar protuberance at the second end 24 to restrict the straw's 20 removal from the hollow sleeve 42. However, it can be appreciated by one skilled in the art that other embodiments of the present invention may include straws 20 of various shapes and structures.

The candy component 30 is designed with an opening sized to the diameter of the straw 20 to allow the candy component 30 to be affixed to the straw 20. The straw 20 is preferably embedded less than completely through the candy component 30. The candy component 30 is designed to allow the drawing of a liquid through the straw 20 and the candy component 30. The candy component 30 may be designed with one hole 34 traveling through the candy component 30 to the straw 20 or with a plurality of holes 34. The candy component 30 may be shaped like a lollipop sucker having a flat circular shape or a spherical shape. However, it can be appreciated by one skilled in the art that other embodiments of the present invention may include candy components 30 of various shapes and sizes.

The candy component 30 may be sweet, sour, salty, bitter or tart tasting. The candy component 30 may be made in a variety of flavors, textures and consistencies. The candy component 30 may be made from material which will effervesce upon reaction with a fluid. In addition, the candy component may mix flavors, textures and consistencies. The candy component 30 can be made of any dissolvable product which can be affixed to the straw 20 and will allow liquid to be drawn through it.

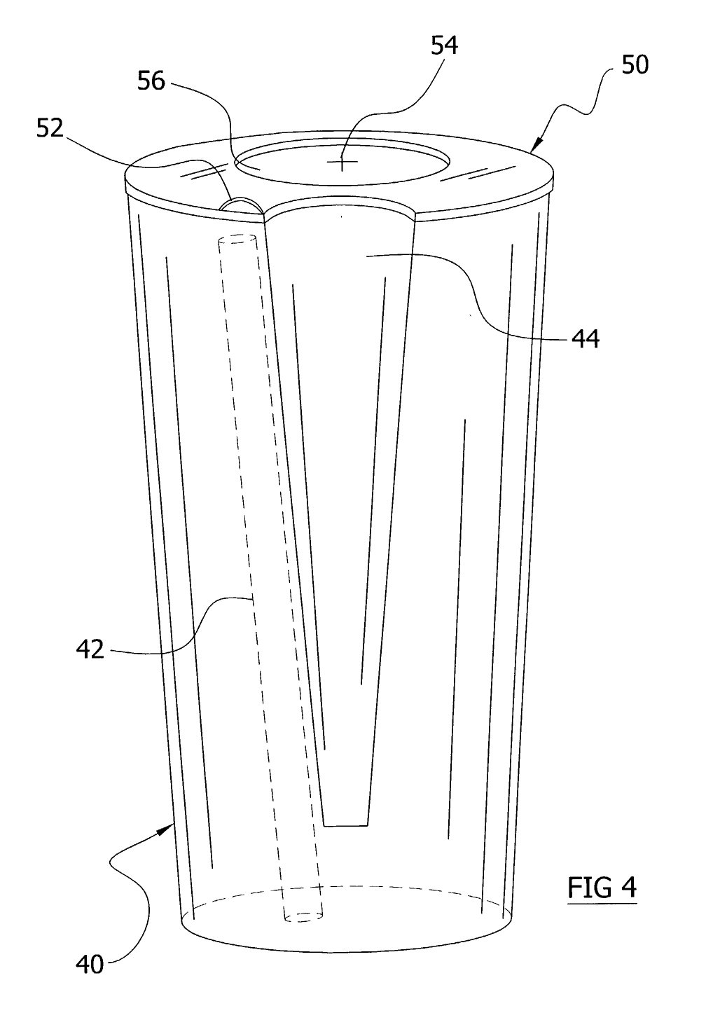

As best seen in FIG. 4, the fluid-holding container 40 has a hollow tapered cylindrical shape with a top end and a bottom end wherein the bottom end is sealed. The fluid-holding container 40 is preferably designed with an indention 44 along the inner surface of the container. The indention 44 may be shaped in a tapered semi-cylindrical shape or other well-known shapes. Along the inside wall of the fluid-holding container 40, beginning at a point below the top end of the fluid-holding container 40 and ending at a point above the bottom end of the fluid-holding container 40, is a hollow sleeve 42. The hollow sleeve 42 is of a diameter to allow the straw 20 to be inserted into the hollow sleeve 42. The hollow sleeve 42 may traverse along an edge of the indention 44. The fluid-holding container 40 may be made from a variety of materials. The fluid-holding container 40 may be made in a variety of colors, shapes and sizes, which may include printed or imbedded designs. The hollow sleeve 42 may be attached via many methods sufficient to the art, and may be of any length sufficient to support the straw 20 and candy component 30, which will retain the candy component 30 in a single fluid-holding container 40 when the fluid-holding container 40 and straw 20 with candy component 30 is dislodged from a stack of fluid-holding containers 40.

The straw 20 may be affixed to the hollow sleeve 42 using glue or some similar method.

As best seen in FIG. 7, the covering lid 50 is designed in a shape to correspond to the shape of the top end of the fluid-holding container 40. The covering lid 50 has a cutout 52 shaped and at a diameter to allow the insertion of the straw 20. The covering lid 50 contains penetrable score lines 54 to allow the insertion of additional straws 20 or standard commercially available straws. The covering lid 50 has a circular recessed portion 56 to provide additional support to the covering lid 50.

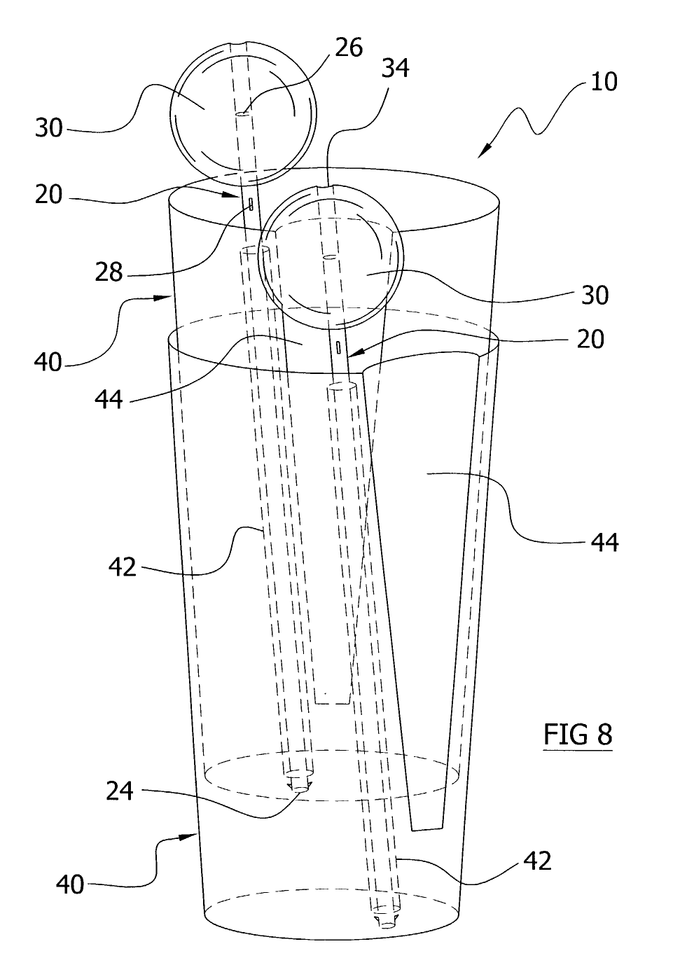

FIG. 8 shows the method of stacking multiple flavor enhancing drinking systems 10. The straw 20 may be constructed or affixed to the hollow sleeve 42 sufficiently to prevent the candy component 30 and straw 20 from becoming dislodged when a fluid-holding container 40 is removed from a stack of fluid-holding containers 40.

In use, a fluid-holding container 40 with inserted straw 20 and attached candy component 30 is separated from a stack, as seen in FIG. 8, of fluid-holding containers 40. The fluid-holding container 40 is then filled with a liquid of choice. A covering lid 50 may be affixed atop the fluid-holding container 40 to prevent spillage of the liquid.

The user may then draw the fluid to their mouth using a plurality of methods. The user may place their lips over the aperture 28 in the straw and draw the fluid through only the candy component 30 section. The user may place their tongue on the hole 34 on the candy component 30 and place their lips past the aperture 28 in the straw 20 and draw the fluid only through the aperture 28. The user may place their lips past the aperture 28 and draw the fluid from both the aperture 28 and the candy component 30 section. Lastly, the straw 20 with candy component 30 attached may be taken out of the hollow sleeve 42 and placed in the liquid and the user draw the liquid from the hole 34 of the candy component 30 and/or the aperture 28 of the straw 20.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A flavor enhancing drinking system, comprising:
a straw having a first end and a second end;
a candy component having a longitudinal length; and
said first end of said straw embedded into said candy component at a length less than said longitudinal length, allowing a liquid to be drawn through said straw and said candy component.

2. The flavor enhancing drinking system of claim 1, wherein said first end of said straw partially extends into said candy component.

3. The flavor enhancing drinking system of claim 1, wherein said candy component has at least one hole in fluid connection with said first end of said straw.

4. The flavor enhancing drinking system of claim 1, wherein said candy component has a plurality of shapes.

5. A flavor enhancing drinking system, comprising:
a straw having a first end and a second end;
a candy component having a longitudinal length;
said first end of said straw embedded into said candy component at a length less than said longitudinal length allowing a liquid to be drawn through said straw and said candy component; and
at least one aperture within said straw positioned between said second end and said candy component.

6. The flavor enhancing drinking system of claim 5, wherein said first end of said straw partially extends into said candy component.

7. The flavor enhancing drinking system of claim 5, wherein said candy component has at least one hole in fluid connection with said first end of said straw.

8. The flavor enhancing drinking system of claim 5, wherein said candy component has a plurality of shapes.

9. The flavor enhancing drinking system of claim 5, wherein said candy component has an outer shell and a hollow center.

10. A flavor enhancing drinking system, comprising:
a straw having a first end and a second end;
a candy component having a longitudinal length;
said first end of said straw embedded into said candy component at a length less than said longitudinal length allowing a liquid to be drawn through said straw and said candy component;
at least one aperture within said straw positioned between said second end and said candy component; and
a container having a wall, an open top end and a sealed bottom end.

11. The flavor enhancing drinking system of claim 10, wherein said container is tapered from the said top end to said bottom end.

12. The flavor enhancing drinking system of claim 10, wherein said container has an indention within said wall in a vertical manner.

13. The flavor enhancing drinking system of claim 10, wherein said container has a sleeve attached to an inner surface of said wall, wherein said sleeve removably receives a portion of said straw.

14. The flavor enhancing drinking system of claim 10, wherein said sleeve extends substantially parallel to an edge of said indention.

15. The flavor enhancing drinking system of claim 10, including a covering lid affixable to said top end of said container.

16. The flavor enhancing drinking system of claim 15, wherein said covering lid has a cutout corresponding with said sleeve.

17. The flavor enhancing drinking system of claim 15, wherein said covering lid includes at least one penetrable score line.

18. The flavor enhancing drinking system of claim 15, wherein said covering lid has a recessed portion within said lid surrounding said at least one penetrable score line.
